(19) United States
(12) Patent Application Publication
(10) Pub. No.: US 2021/0387594 A1
(43) Pub. Date: Dec. 16, 2021

(54) DIGITAL CONTACTLESS SIGNING SYSTEM FOR FLEXIBLE TOBACCO DISTRIBUTION

(71) Applicant: Chengdu Branch of Sichuan Tobacco Company, Chengdu City (CN)

(72) Inventors: Jiankang Yin, Chengdu City (CN); Yong Cai, Chengdu City (CN); Hongwen Song, Chengdu City (CN); Xiaozhou Zhu, Chengdu City (CN); Ning Liu, Chengdu City (CN); Weidong Zhang, Chengdu City (CN); Xiaofeng Hu, Chengdu City (CN); Maobo Li, Chengdu City (CN); Lin Zhang, Chengdu City (CN); Shaohu Zhu, Chengdu City (CN); Guanyang Wen, Chengdu City (CN); Xing Zhou, Chengdu City (CN); Aijun Ma, Chengdu City (CN); Wenquan Zhang, Chengdu City (CN); Haizhou Hong, Chengdu City (CN); Hongmei He, Chengdu City (CN); Dayu Ou, Chengdu City (CN); Ziwei Chen, Chengdu City (CN); Yan Liu, Chengdu City (CN); Pengying Xiao, Chengdu City (CN); Qiuxuan Fu, Chengdu City (CN)

(21) Appl. No.: 17/232,778

(22) Filed: Apr. 16, 2021

(30) Foreign Application Priority Data
Jun. 11, 2020 (CN) 202010532451.5

(51) Int. Cl. B60R 25/24; G07C 5/00; G06Q 10/00; G06K 7/14; G06Q 50/28; H04L 9/32; G01S 19/14; B60R 25/30; B60R 25/33; B60P 3/025

(52) U.S. Cl. CPC B60R 25/24; G07C 5/006; G06Q 10/20; G06K 7/1417; B60P 3/0257; H04L 9/3247; G01S 19/14; B60R 25/305; B60R 25/33; G06Q 50/28

(57) ABSTRACT

The disclosure provides a digital contactless signing system for the flexible tobacco distribution, which comprises a cigarette store, a vehicle system, a vehicle access system, a database, a historical database, a server, an information entry unit, an information transmission unit, a distribution system, a client terminal and a two-dimensional code information unit, wherein the cigarette store is connected with the vehicle access system connected with the vehicle access system. The disclosure changes paper tickets into network electronic tickets, and adopts two-dimension code scanning to complete a confirmation of the tobacco handing-over between a distributor and a customer, thereby effectively saving expenses of the paper tickets. An error rate of the signing system is extremely low and almost close to zero due to changing the paper tickets to the network electronic tickets, and a whole data accuracy is improved for signing for the cigarette materials.

### CROSS REFERENCE TO RELATED APPLICATION

This application claims the benefit of priority to Chinese Patent Application No. 202010532451.5 titled “digital contactless signing system for flexible tobacco distribution”, filed with the Chinese State Intellectual Property Office on Jun. 11, 2020, the entire disclosure of which is incorporated herein by reference.

### TECHNICAL FIELD

The disclosure relates to the field of logistics technology, and in particular to a digital contactless signing system for a flexible tobacco distribution.

### BACKGROUND ART

Cigarettes are tobacco products in which cut tobacco is rolled into strips with cigarette paper, also known as paper cigarettes, pimp sticks, or cigarette roll, and include filter cigarettes and non-filter cigarettes, and are divided into cigarettes with light and strong flavors. Currently in the domestic cigarette market, the cigarettes mainly have lengths of 84 mm, 100 mm, 90 mm, and 70 mm, and diameters of 7.7 mm for most of the cigarettes produced by domestic cigarette companies, and 7.8 mm for imported cigarettes, and internationally popular cigarettes have a length of 84 mm and a diameter of 7.8 mm, which is a cigarette specification calculated by the world cigarette industry through scientific experiments on smokers for hundreds of years. In recent years, thin cigarettes have been actively developed by the State Tobacco Monopoly Administration. Once upon a time, the thin cigarette refers to the cigarette with the diameter of less than 7.7 mm, and a length generally longer than 84 mm, such as about 90-100 mm, for aesthetic reasons, therefore, an appearance of the thin cigarette is slender. Air permeability of the cigarette is determined by the cigarette paper and wrapping paper of filter tips. Higher air permeability of the cigarette has a greater impact on a smoking effect, since tar and nicotine in the cigarette can be diluted with a mild cigarette flavor due to a proportion of the air mixed with a smoke increasing. However, too high air permeability may increase the time and depth of each puff, resulting in a greater impact on health. A method for testing the air permeability is as follows: putting the cigarette in one's mouth to blow and suck a few times with the other end of the cigarette blocked. Tobacco logistics in a broad sense refers to a movement of physical entities in an entire process from production, acquisition, storage, transportation, processing to sales service of raw materials of the tobacco and its products, and all additional value-added activities in circulation links. The cigarette is a type of tobacco. Tobacco in a narrow sense refers to the movement of the tobacco products and related physical materials in industrial companies, commercial companies and between each other based on different division of social functions in tobacco industry. The tobacco products belong to the state monopoly, which requires strong control over the entire production and sales process of the tobacco products. The cigarettes, as one of the most important sources of national tax revenue, have long implemented a planned production and monopoly management system in our country. Therefore, it is necessary to support the sustained and rapid development of the entire industry with a strong logistics distribution system, to calmly deal with challenges and risks brought by the market environment. Simultaneously with the State Tobacco Monopoly Administration, many local tobacco giants are also doing drastic transformation and reconstruction of their own logistics information management.

Currently, a general receipt confirmation mode of cigarette logistics is that two full-time staffs use five high speed line printers to print “delivery receipts” corresponding to retail customers, and then deliverymen delivery the paper “delivery receipts” to the retail customers for receipt confirmation, which is very troublesome, and requires a large amount of paper tickets, easy to be confused and lost, and costly. To this end, it is proposed to a digital contactless sign-in system for a flexible tobacco distribution.

### SUMMARY

The disclosure intends to provide a digital contactless signing system for a flexible tobacco distribution to solve the problems proposed in above background art.

The present disclosure is implemented by the following technical solutions: the digital contactless signing system for the flexible tobacco distribution, comprising:

a cigarette store, a vehicle system, a vehicle access system, a database, a historical database, a server, an information entry unit, an information transmission unit, a distribution system, a client terminal and a two-dimensional code information unit, wherein the cigarette store is connected with the vehicle access system, the vehicle system is connected with the vehicle access system, the vehicle access system is connected with the server, the server is connected with the database, the server is connected with the historical database, the server is connected with the information entry unit, the server is connected with the information transmission unit, the information transmission unit is connected with the distribution system, the distribution system is connected with the client terminal, and the client terminal is connected with the two-dimensional code information unit.

Optionally, the vehicle system comprises a GPS positioning unit, a GPS position comparing unit, a data processing unit, a vehicle control unit and a vehicle unit, wherein the GPS positioning unit is connected with the GPS position comparing unit, the GPS position comparing unit is connected with the data processing unit, the data processing unit is connected with the vehicle control unit, and the vehicle control unit is connected with the vehicle unit.

Optionally, the vehicle access system comprises a data invoking unit, an identification unit and a camera recognition unit, wherein the data invoking unit is connected with the identification unit, and the camera recognition unit is connected with the identification unit.

Optionally, the distribution system comprises a data information feedback unit, a GPS positioning unit, a maintenance feedback unit, an information recording unit, a data entry unit, a distribution video recording unit, a distribution terminal, a code scanning unit, a data processing unit, an ID input unit, an ID comparing unit and a data compensation unit, wherein the ID input unit is connected with the distribution terminal, the ID comparing unit is connected with the distribution terminal, the distribution terminal is connected with the distribution video recording unit, and the distribution terminal is connected with the code scanning unit.

Optionally, the maintenance feedback unit is connected with the information recording unit, the data information feedback unit is connected with the information recording unit, the GPS positioning unit is connected with the information recording unit, and the data entry unit is connected with the information recording unit.

Optionally, the information recording unit is connected with the data processing unit, and the data processing unit is connected with the data compensation unit.

Optionally, the information transmission unit is connected with the data processing unit, the information transmission unit is connected with the ID comparing unit, and an information transmission unit is connected with the distribution terminal.

Optionally, the server is connected with the data invoking unit.

Advantages of the present disclosure are as follows: expenses of the paper tickets are saved by changing paper tickets to network electronic tickets, and adopting two-dimensional code scanning to complete a confirmation of the tobacco handing-over between a distributor and a customer. Meanwhile, an error rate of the signing system is extremely low and almost close to zero due to changing the paper tickets to the network electronic tickets, and a whole data accuracy is improved for signing for the cigarette materials. Meanwhile, the signing mode does not need a customer signature, and reduces the contact frequency between the distributor and the customer, and a disease transmission risk in a special environment of an epidemic transmission.

### BRIEF DESCRIPTION OF THE DRAWINGS

In order to more clearly illustrate the embodiments of the present disclosure or technical solutions in the related art, the accompanying drawings used in the embodiments or the related art will now be described briefly. It is obvious that the drawings in the following description are only some embodiments of the disclosure, and that those skilled in the art can obtain other drawings from these drawings without any inventive effort.

FIG. 1 is a schematic block diagram of the present disclosure;

FIG. 2 is a schematic block diagram of a distribution system according to the present disclosure;

FIG. 3 is a schematic block diagram of a vehicle system according to the present disclosure;

FIG. 4 is a schematic block diagram of a vehicle access system according to the present disclosure.

### DETAILED DESCRIPTION OF THE EMBODIMENTS

In the following, the technical solutions in the embodiments of the present disclosure will be clearly and completely described with reference to the drawings in the embodiments of the present disclosure. Obviously, the described embodiments are only a part of the embodiments of the present disclosure, but not all the embodiments thereof. Based on the embodiments of the present disclosure, all other embodiments obtained by those skilled in the art without any creative efforts shall fall within the scope of the present disclosure.

### EMBODIMENTS

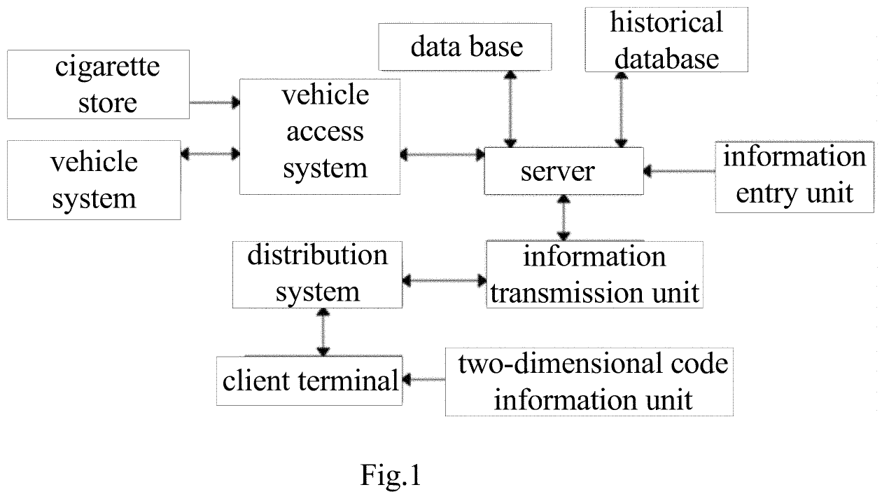

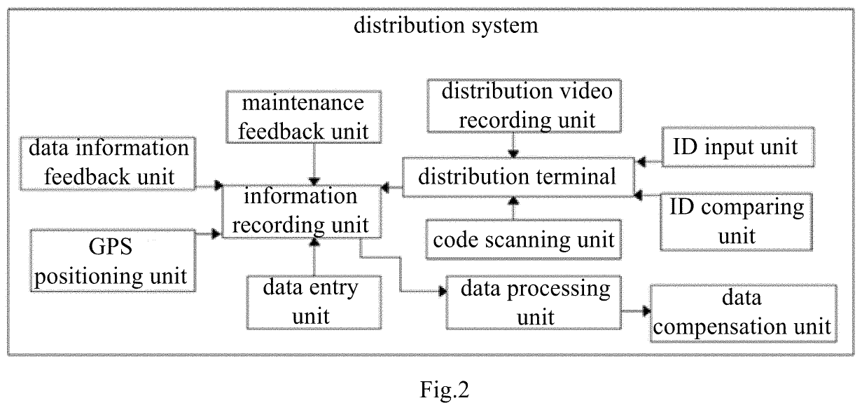

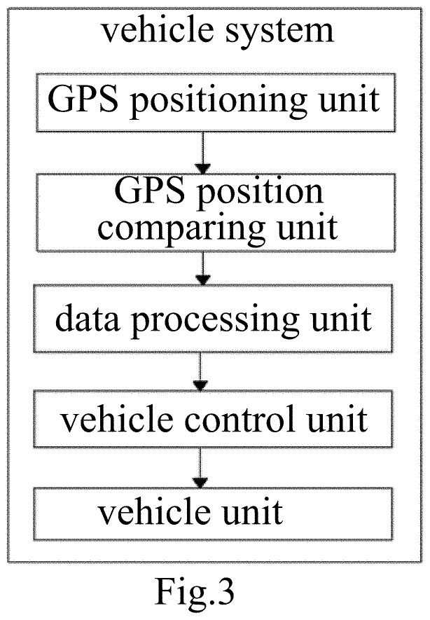

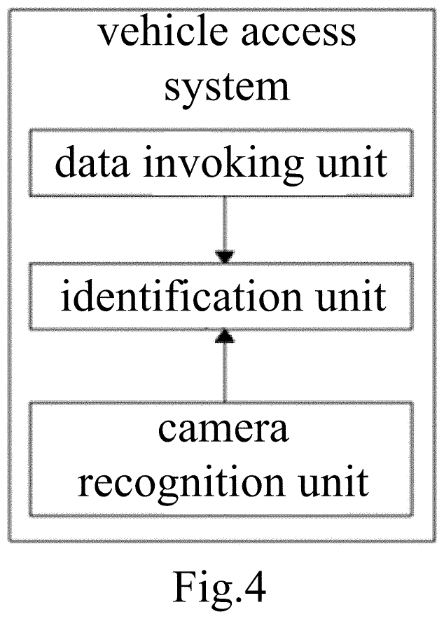

As shown in FIGS. 1-4, the disclosure provides a technical solution of a digital contactless signing system for a flexible tobacco distribution, which includes:

a cigarette store, a vehicle system, a vehicle access system, a database, a historical database, a server, an information entry unit, an information transmission unit, a distribution system, a client terminal and a two-dimensional code information unit, wherein the cigarette store is connected with the vehicle access system, the vehicle system is connected with the vehicle access system, the vehicle access system is connected with the server, the server is connected with the database, the server is connected with the historical database, the server is connected with the information entry unit, the server is connected with the information transmission unit, the information transmission unit is connected with the distribution system, the distribution system is connected with the client terminal, and the client terminal is connected with the two-dimensional code information unit. The vehicle system comprises a GPS positioning unit, a GPS position comparing unit, a data processing unit, a vehicle control unit and a vehicle unit, wherein the GPS positioning unit is connected with the GPS position comparing unit, the GPS position comparing unit is connected with the data processing unit, the data processing unit is connected with the vehicle control unit, and the vehicle control unit is connected with the vehicle unit. The vehicle access system comprises a data invoking unit, an identification unit and a camera recognition unit, wherein the data invoking unit is connected with the identification unit, and the camera recognition unit is connected with the identification unit. The distribution system comprises a data information feedback unit, a GPS positioning unit, a maintenance feedback unit, an information recording unit, a data entry unit, a distribution video recording unit, a distribution terminal, a code scanning unit, a data processing unit, an ID input unit, an ID comparing unit and a data compensation unit, wherein the ID input unit is connected with the distribution terminal, the ID comparing unit is connected with the distribution terminal, the distribution terminal is connected with the distribution video recording unit, and the distribution terminal is connected with the code scanning unit. The maintenance feedback unit is connected with the information recording unit, the data information feedback unit is connected with the information recording unit, the GPS positioning unit is connected with the information recording unit, and the data entry unit is connected with the information recording unit. The information recording unit is connected with the data processing unit, and the data processing unit is connected with the data compensation unit. The information transmission unit is connected with the data processing unit, the information transmission unit is connected with the ID comparing unit, and an information transmission unit is connected with the distribution terminal. The server is connected with the data invoking unit.

Working principle or structural principle is as follows: the server is provided with an interactive software installed in both the client terminal and the distribution terminal. A two-dimensional code is issued to a customer who retails cigarettes. The two-dimensional code information unit is configured to store and display the two-dimensional code. A user name and a password are input through the information entry unit. The server is configured to store the user name and the password into the database. When the cigarette is distributed, task data is input by a staff using the information entry unit. The server stores the task data into the historical database for subsequent viewing. The server transmits the task data to the distribution terminal through the information transmission unit. The distributor logs in the distribution terminal through the user name and the password to obtain the task data. The distributor checks the vehicle unit according to the task, selects the vehicle unit matching the task for distribution, and meanwhile, the distributor writes a starting time of a freight transportation using the data entry unit. The data is transmitted to the data processing unit by the information recording unit, and transmitted to the server by the information transmission unit, and then stored in the database and the historical database. The distributor writes an ending time of the freight transportation using the data entry unit. The data is transmitted to the data processing unit by the information recording unit, and transmitted to the server by the information transmission unit, and then stored in the database and the historical database. The task data is transmitted by the server to the vehicle access system. When the distributor drives the vehicle unit to the vehicle access system, GPS data and vehicle model data of the task may be invoked by the data invoking unit of the vehicle access system, information of a vehicle unit may be recognized by the camera recognition unit. The identification unit is configured to compare the GPS data and the vehicle model data and the information of the vehicle unit, and the vehicle is allowed to pass through if the comparison result is consistent. When vehicle enters and exits the store, the data invoking unit may record both entering time data and exiting time data, and send them to the server. The entering time data and the exiting time data are stored in the database and the historical database by the server. After the distributor logs in the user name and the password, the GPS positioning unit records the real-time position of the distributor, and sends the data of the real-time position to the information recording unit. Then the data of the real-time position is transmitted to the data processing unit by the information recording unit, and transmitted to the server through the information transmission unit. The data of the real-time position is stored in the database and the historical database by the server. When a network gets worse, the data obtained by the data processing unit is temporarily stored in the data compensation unit. When the network gets better, the temporarily stored data may be sent to the server by the information transmission unit, and then stored in the database and the historical database by the server. During distributing, journey data of the distributor is entered into the data recording unit through the data entry unit and transmitted to the server through the data processing unit and the information transmission unit. When the distributor drives the vehicle unit to arrive at a position of the customer, the customer shows the two-dimensional code information unit through the client terminal, and the distributor scans the two-dimensional code information unit through the code scanning unit of the distribution terminal to accomplish delivery. When the customer is absent, the distributor records information through the distribution video recording unit of the distribution terminal to transmit the information to the server through the data information feedback unit, the information recording unit, the data processing unit and the information transmission unit for temporary buffering. When the vehicle unit breaks down, the distributor may record specific information of the vehicle into the information recording unit through the maintenance feedback unit to send the information to the server through the data processing unit and the information transmission unit. The staff may enter agent tasks such as market investigation and information collection through the information entry unit to transmit the information of the agent tasks to the distribution terminal through the server and the information transmission unit, so that the distributor may conveniently obtain the tasks.

The above description is only for the purpose of illustrating the preferred embodiments of the present disclosure and should not be taken as limiting the scope of the present disclosure, which is intended to cover any modifications, equivalents and improvements, etc. within the spirit and scope of the present disclosure.

1. A digital contactless signing system for a flexible tobacco distribution, comprising:
a cigarette store, a vehicle system, a vehicle access system, a database, a historical database, a server, an information entry unit, an information transmission unit, a distribution system, a client terminal and a two-dimensional code information unit,
wherein the cigarette store is connected with the vehicle access system, the vehicle system is connected with the vehicle access system, the vehicle access system is connected with the server, the server is connected with the database, the server is connected with the historical database, the server is connected with the information entry unit, the server is connected with the information transmission unit, the information transmission unit is connected with the distribution system, the distribution system is connected with the client terminal, and the client terminal is connected with the two-dimensional code information unit.

2. The digital contactless signing system for the flexible tobacco distribution according to claim 1, wherein, the vehicle system comprises a GPS positioning unit, a GPS position comparing unit, a data processing unit, a vehicle control unit and a vehicle unit, and wherein, the GPS positioning unit is connected with the GPS position comparing unit, the GPS position comparing unit is connected with the data processing unit, the data processing unit is connected with the vehicle control unit, and the vehicle control unit is connected with the vehicle unit.

3. The digital contactless signing system for the flexible tobacco distribution according to claim 1, wherein, the vehicle access system comprises a data invoking unit, an identification unit and a camera recognition unit, and wherein, the data invoking unit is connected with the identification unit, and the camera recognition unit is connected with the identification unit.

4. The digital contactless signing system for the flexible tobacco distribution according to claim 1, wherein, the distribution system comprises a data information feedback unit, a GPS positioning unit, a maintenance feedback unit, an information recording unit, a data entry unit, a distribution video recording unit, a distribution terminal, a code scanning unit, a data processing unit, an ID input unit, an ID comparing unit and a data compensation unit, and wherein, the ID input unit is connected with the distribution terminal, the ID comparing unit is connected with the distribution terminal, the distribution terminal is connected with the distribution video recording unit, and the distribution terminal is connected with the code scanning unit.

5. The digital contactless signing system for the flexible tobacco distribution according to claim 4, wherein, the maintenance feedback unit is connected with the information recording unit, the data information feedback unit is connected with the information recording unit, the GPS positioning unit is connected with the information recording unit, and the data entry unit is connected with the information recording unit.

6. The digital contactless signing system for the flexible tobacco distribution according to claim 4, wherein, the information recording unit is connected with the data processing unit, and the data processing unit is connected with the data compensation unit.

7. The digital contactless signing system for the flexible tobacco distribution according to claim 4, wherein, the information transmission unit is connected with a data processing unit, the information transmission unit is connected with an ID comparing unit, and an information transmission unit is connected with a distribution terminal.

8. The digital contactless signing system for the flexible tobacco distribution according to claim 3, wherein, the server is connected with a data invoking unit.
